(19) United States
(12) Patent Application Publication
(10) Pub. No.: US 2007/0295281 A1
(43) Pub. Date: Dec. 27, 2007

(54) Combination pet grooming device and towel

(76) Inventors: David A. Fortson, Santa Barbara, CA (US); John R. Stump, Santa Barbara, CA (US)

Correspondence Address: SANDRA LEE LIPKIN;A LAW CORPORATION, 1891 GOODYEAR AVE., SUITE 622, VENTURA, CA, 93003, US

(21) Appl. No.: 11/818,091

(22) Filed: Jun. 12, 2007

Related U.S. Application Data
(60) Provisional application No. 60/814,999, filed on Jun. 21, 2006.

(51) Int. Cl. A01K 13/00

(52) U.S. Cl. 119/601; 119/613

(57) ABSTRACT

A combination all-in-one device that provides for the drying and grooming of an animal, such as a dog after an activity that results in the animal becoming wet. Once the animal has gotten wet, the device of the invention provides a single item that has a towel on one side that can dry the animal. Provided on the opposite side of the towel is a grooming side made of flexible bristles that can comb the hair of an animal. The bristles of the grooming side vary in size and composition based on the animal to be dried and groomed. The grooming side of the device has recessed portions for placement of the user's hands when utilizing the towel side of the device. The towel side of the device has means for activating the grooming side, such as recessed gripping pads or handles. The composition of the materials to make the towel side are also variable depending upon the type of animal upon which is to be utilized. The grooming side of the device can also be used as a barrier to any surface that needs to stay dry, such as the vehicle of the owner, that provides a place for the animal to rest without getting the surface wet.

### REFERENCE TO PRIOR APPLICATION

This application claims the priority of provisional application 60/814,999, filed Jun. 21, 2006 entitled COMBINATION PET GROOMING DEVICE AND TOWEL by David A. Fortson and John R. Stump.

### BACKGROUND OF THE INVENTION

1. Field of the Invention

The present invention relates generally to the field of pet grooming products, and specifically to a product that combines the advantages of a towel for drying an animal with a brush for grooming the hair of an animal.

2. Description of the Prior Art

Pet owners are desirous of keeping their pets clean, well-groomed and happy. Pet owners often like to recreate with their pets. An example of this is when a pet owner takes his dog to the beach, river, lake or pool at which point the dog can join the leisure activity and enjoy the water with its owner. At the end of such an outing, the dog is usually wet, often dirty, and almost always his hair is in disarray.

In a situation like this, it is quite common for the dog owner to have planned ahead and brought a towel to dry the dog. Less likely, however, is it that the pet owner has also brought along a grooming device, such as a brush to groom the dog to control the dog's hair and to remove any dirt or other debris that has collected in the dog's coat. Furthermore, the wet dog is often times placed in the vehicle of the owner after such play, leaving the seat wet and soiled because the towel used to dry the dog has been completely wetted.

Prior art in the field includes towels, certainly, and also pet brushes. However, conventional pet brushes are typically of limited size and only allow for the grooming of a small area on an animal. Furthermore, while the bringing of a towel is usually contemplated by a pet owner prior to an excursion that is likely to result in a wet dog, a brush is not usually brought along.

Heretofore, there has not existed a single device that can dry the dog, groom the dog, and provide added benefit, such as protection of the owner's vehicle by providing a dry placemat for the dog once in the vehicle after a recreational outing resulting in a wet dog. It is the object of the present invention to overcome the shortcomings of the prior art and provide a single device that can achieve the ends heretofore unachievable by the prior art.

### SUMMARY OF THE INVENTION

The preferred embodiment of the present invention teaches a combination device for drying and grooming an animal comprising a first side composed of an absorbent material; a second side composed of a plurality of flexible bristles; wherein the first and second side are attached directly to each other with the first side facing in the opposite direction from the second side.

The above embodiment can be further modified by defining that the first side further comprises one or more recessed gripping pads to facilitate the use of the flexible bristles on the second side.

The above embodiment can be further modified by defining that the first side further comprises one or more gripping handles to facilitate the use of the flexible bristles on the second side.

The above embodiment can be further modified by defining that the gripping handles are made of rubber.

The above embodiment can be further modified by defining that the first side is made of cotton.

The above embodiment can be further modified by defining that the first side is made of chamois.

The above embodiment can be further modified by defining that the first side is made of micro-fiber.

The above embodiment can be further modified by defining that the second side further comprises one or more recessed portions to facilitate the use of the absorbent material on the first side.

The above embodiment can be further modified by defining that the recessed portions are made of smooth rubber.

A second embodiment teaches a method for drying and grooming an animal comprising utilizing a device that is a combination device further comprising a first side composed of an absorbent material; a second side composed of a plurality of flexible bristles; wherein the first and second side are attached directly to each other with the first side facing in the opposite direction from the second side.

The above embodiment can be further modified by defining that the first side further comprises one or more recessed gripping pads to facilitate the use of the flexible bristles on the second side.

The above embodiment can be further modified by defining that the first side further comprises one or more gripping handles to facilitate the use of the flexible bristles on the second side.

The above embodiment can be further modified by defining that the gripping handles are made of rubber.

The above embodiment can be further modified by defining that the first side is made of cotton.

The above embodiment can be further modified by defining that the first side is made of chamois.

The above embodiment can be further modified by defining that the first side is made of micro-fiber.

The above embodiment can be further modified by defining that the second side further comprises one or more recessed portions to facilitate the use of the absorbent material on the first side.

The above embodiment can be further modified by defining that the recessed portions are made of smooth rubber.

### BRIEF DESCRIPTION OF THE DRAWINGS

FIG. 1 is a top view of the towel side of the invention showing hand pockets that cover the recessed portions for gripping and a loop for hanging.

FIG. 2 is a top view of the towel side of the invention without the hand pockets, showing the recessed portions for gripping.

FIG. 3 is an isometric view of the towel side of the invention without the hand pockets, showing the recessed portions for gripping.

FIG. 4 top view of the bristle side of the invention.

FIG. 5 is a top close up view of the bristle pattern on the bristle side of the invention.

FIG. 5a is taken along the line 5a-5a in FIG. 5

FIG. 5b is an isometric close up view of the bristle pattern on the bristle side of the invention.

FIG. 6 is a close up view of the pocket trim stitch on the hand pockets on the towel side of the invention.

FIG. 7 is a close up view of the inside of a hand pocket on the towel side of the invention.

FIG. 8 is a view of the hand pocket with a hand placed therein.

FIG. 9 is a view of the invention in use.

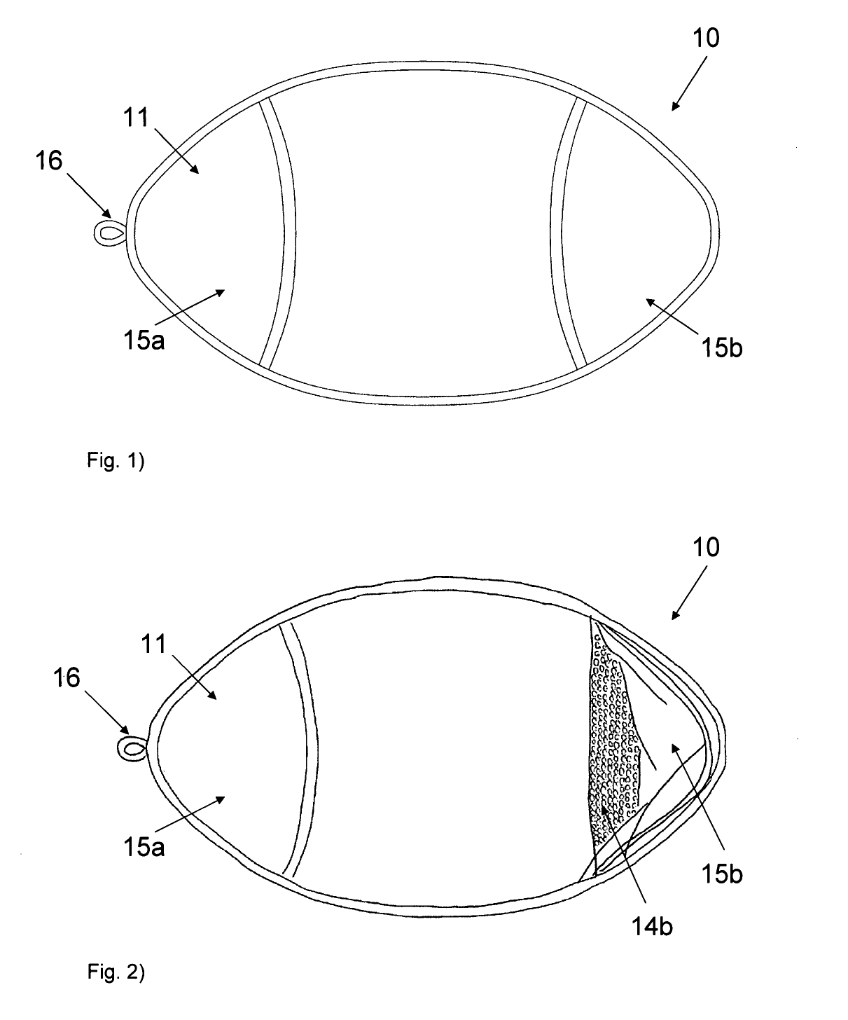

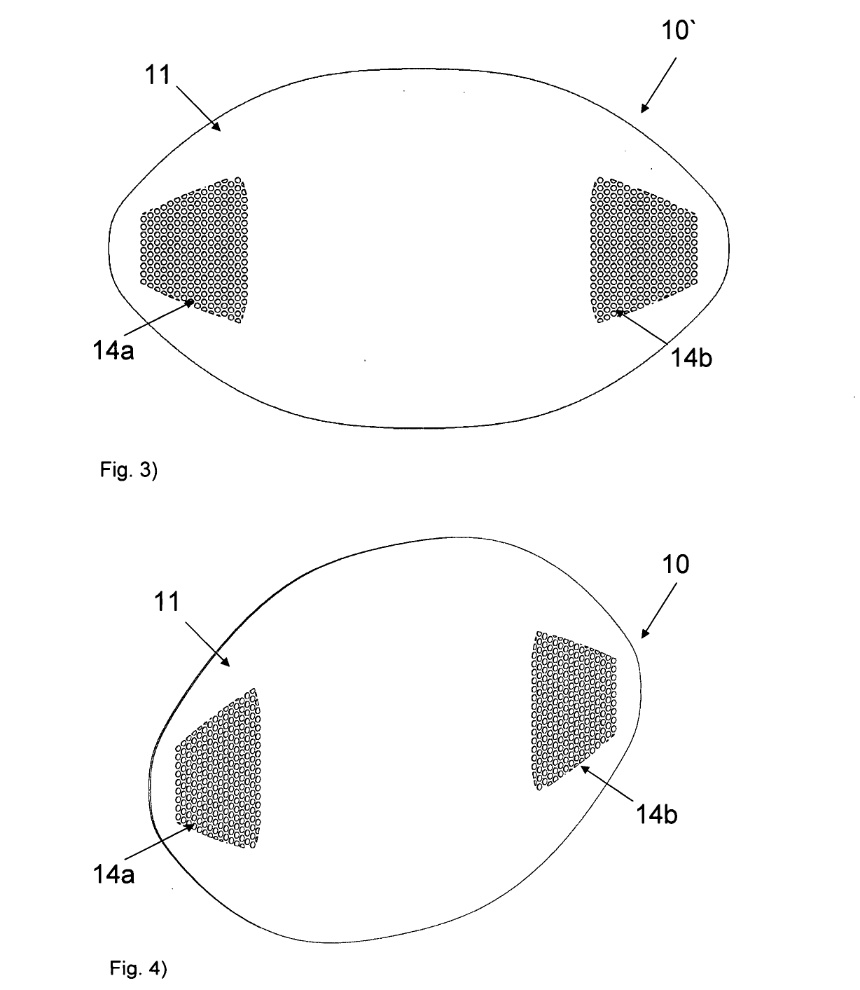

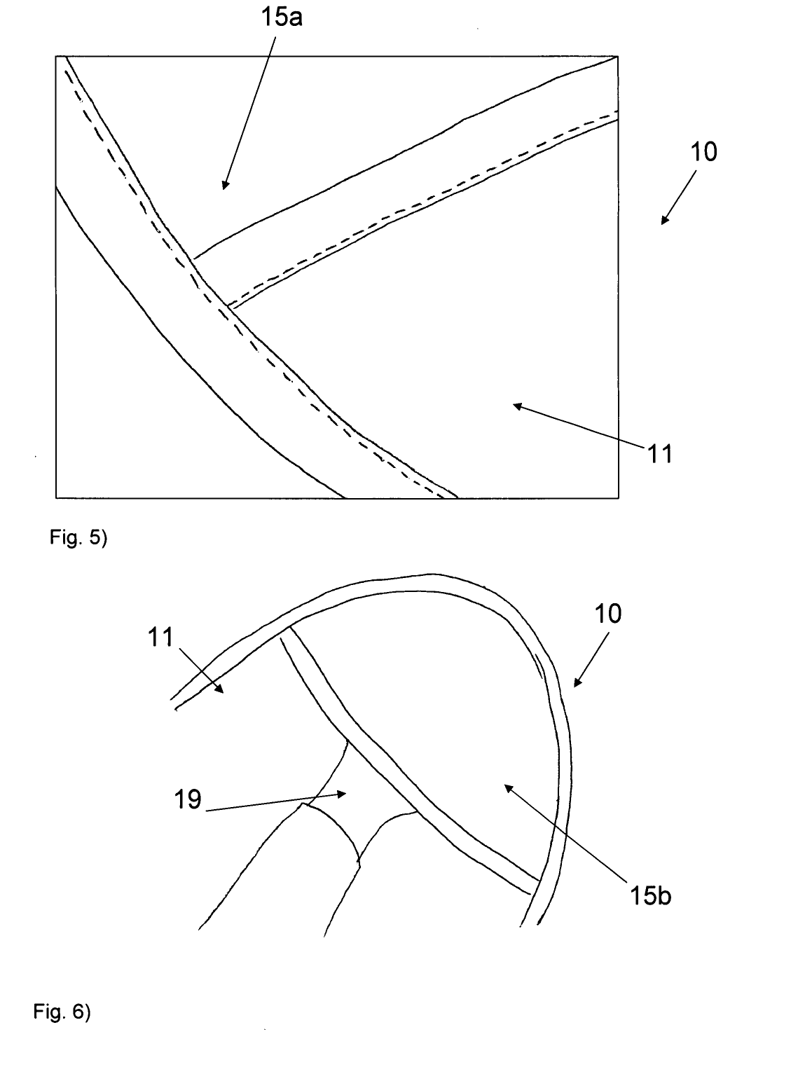

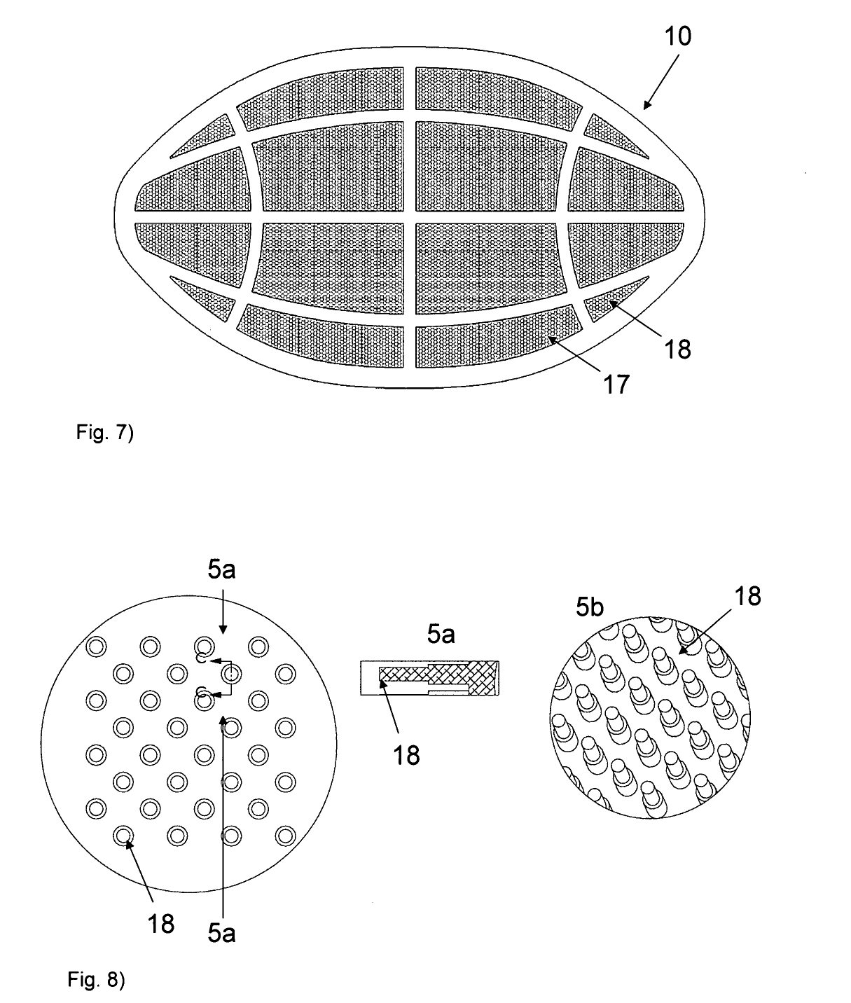

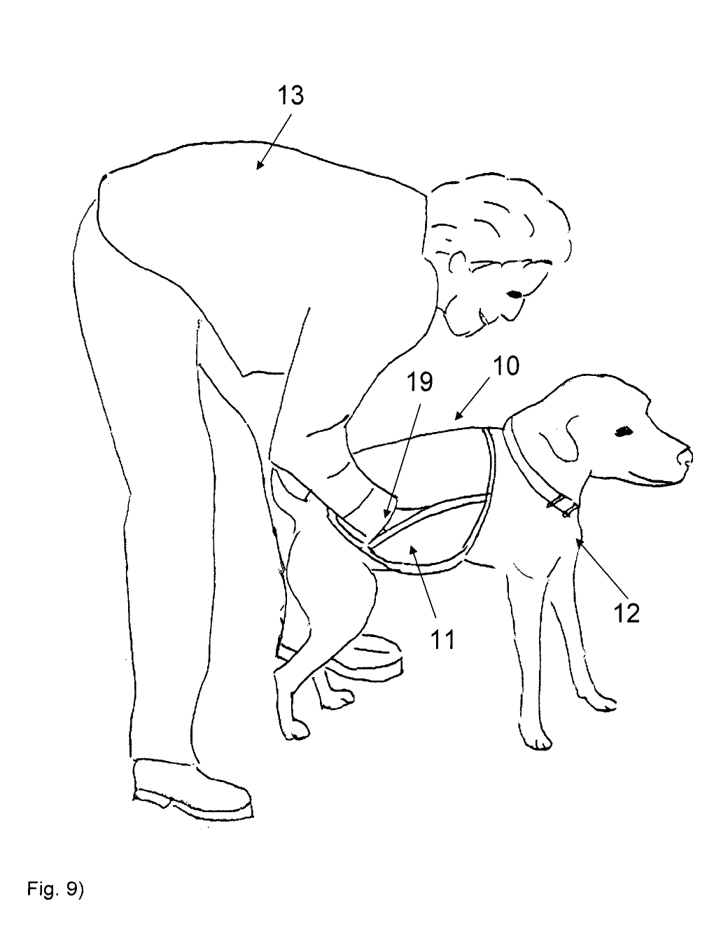

### DETAILED DESCRIPTION OF A PREFERRED EMBODIMENT

Turning to the drawings, the preferred embodiment is illustrated and described by reference characters that denote similar elements throughout the several views of the instant invention.

The first side of the device 10 houses the towel portion 11 of the invention. The towel 11 fulfills a multitude of purposes. Primarily, the towel 11 is meant to provide the pet owner 13 the ability to dry his or her pet 12 after a water activity, such as taking a bath or swimming in a lake, pool, river or the ocean. Additionally, the towel 11 can be placed on the ground, on the floor, in a car, at a park, etc. wherein the owner 13 can offer the animal 12 a comfortable and inviting sitting or laying space. The towel 11 is composed of typical towel materials, such as cotton, chamois or other micro-fiber. Nothing in this specification is meant to be interpreted as a limitation on the composition of material desired to form the towel portion 11 of the device 10. Also on the towel side 11 is a convenient surface 14a, 14b provided for the owner 13 to grip with the owner's hands 19 when using the opposite side of the device, which contains the grooming portion 17 of the invention 10. Pockets 15a, 15b are optionally added to the towel side 11 to cover the gripping surfaces 14a, 14b into which the pet owner 13 inserts his hands 19 to use. Also a loop 16 on the device 10 can provide ease of hanging to dry.

The grooming portion 17 of the invention 10 is composed of a variety of flexible bristles 18. The bristles 18 can be used to remove hair, to clean up the animal's hair if soiled, to stimulate a healthy coat for the animal 12, to offer a bonding moment between pet 12 and owner 13 or to otherwise provide an enjoyable experience for the animal 12 and owner 13. The composition of the materials used to make up the bristles 18 can vary depending on the type of animal, the type of hair and the desired result. In every case, the grooming side 17 should contain flexible bristles 18 to allow for easy folding of the device 10, for fluid motion during the grooming of a larger or small surface area on the animal 12 and for proper usage of the towel side 11 when in use. Contained on the grooming side 17 of the device 10 are several smooth rubber surfaces (not shown) to allow the owner 13 a convenient place to place his or her hands 19 when employing the towel side 11 of the device 10.

An alternate embodiment provides grips (not shown) on the grooming side 17 of the device 10 that sit at the same level as the flexible bristles 18 and offer the owner 13 a convenient place to put his or her hands 19 and grip the device 10 when employing the towel side 11 of the device 10.

The towel 11 is on one side of the device 10 and the grooming portion 17 is the opposite side. This device 10 combines and promotes activities that are healthy for the pet 12 and that are beneficial for the pet/owner relationship. Because the device 10 is multi-purpose and convenient in form and usage, it will be utilized often to the benefit of both the animal 12 and the owner 13.

The device 10 can also offer protection of the owner's vehicle seats from damage or dirt related to the transport of the animal 12. In the event that the owner 13 takes his or her animal 12 to the beach, for example, the device 10 can be used to protect the transport vehicle on the way home from the beach. With the device 10, after the animal 12 plays in the ocean and sand and gets quite wet and dirty, the owner 13 can use the towel side 11 to dry the animal 12. Then the device 10 can be flipped over to the grooming side 17 to remove excess hair and debris from the animal 12 that was loosened during toweling off and play. For the trip home, the grooming side 17 of the device 10 can be placed face down on the vehicle seat so as not to have the wet towel side 11 make the seat wet. The dog 12 can then sit on the towel side 11, thereby protecting the seat from both moisture and debris from the dog 12.

Finally, because of the composition of the device 10, maintenance of cleanliness is simple.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. A combination device for drying and grooming an animal comprising
a first side composed of an absorbent material;
a second side composed of a plurality of flexible bristles;
wherein said first and second side are attached directly to each other with said first side facing in the opposite direction from said second side.

2. The device as defined in claim 1 wherein said first side further comprises one or more recessed gripping pads to facilitate the use of said flexible bristles on said second side.

3. The device as defined in claim 1 wherein said first side is made of cotton.

4. The device as defined in claim 1 wherein said first side is made of chamois.

5. The device is defined in claim 1 wherein said first side is made of micro-fiber.

6. A method for drying and grooming an animal comprising
utilizing a device that is a combination device further comprising
a first side composed of an absorbent material;
a second side composed of a plurality of flexible bristles;
wherein said first and second side are attached directly to each other with said first side facing in the opposite direction from said second side.

7. The method as defined in claim 6 wherein said first side further comprises one or more recessed gripping pads to facilitate the use of said flexible bristles on said second side.

8. The method as defined in claim 6 wherein said first side is made of cotton.

9. The method as defined in claim 6 wherein said first side is made of chamois.

10. The method is defined in claim 6 wherein said first side is made of micro-fiber.
